(19) United States
(12) Patent Application Publication
(10) Pub. No.: US 2021/0173407 A1
(43) Pub. Date: Jun. 10, 2021

(54) SELF-DRIVING SYSTEM WITH TRACKING CAPABILITY

(71) Applicant: LINGDONG TECHNOLOGY (BEIJING) CO.LTD, Beijing (CN)

(72) Inventors: WENQING TANG, Beijing (CN); OU QI, Beijing (CN)

(21) Appl. No.: 16/714,942

(22) Filed: Dec. 16, 2019

(30) Foreign Application Priority Data
Dec. 5, 2019 (CN) 2019112468439

(51) Int. Cl. G05D 1/02; G06K 9/00; G06K 9/20

(52) U.S. Cl. CPC G05D 1/0251; G05D 2201/0216; G06K 9/209; G06K 9/00369

(57) ABSTRACT

A self-driving system includes a mobile base having motorized wheels, one or more cameras operable to identify a target object, one or more proximity sensors operable to measure a distance between the target object and the mobile base, and a controller. The controller directs movement of the motorized wheels based on data received from one or more cameras and proximity sensors, and switches operation mode of the self-driving system from a machine-vision integrated following mode to a pure proximity-based following mode in response to changing environmental conditions so that the self-driving system autonomously follow the target object moving in a given direction, wherein data from the one or more cameras and proximity sensors are both used for following the target object in the machine-vision integrated following mode, and only data from the one or more proximity sensors are used for following the target object in the pure proximity-based following mode.

### BACKGROUND

### Field

Embodiments disclosed herein relate to improved self-driving systems with advanced tracking capability.

### Description of the Related Art

Self-driving systems such as Autonomous Mobile Robots (ARMs) or Automatic Guided Vehicles (AGVs) are driverless, programmable controlled system that can transport a load over long distances. Self-driving systems can provide a safer environment for workers, inventory items, and equipment with precise and controlled movement. Some develops have incorporated sensors to the self-driving systems for following a user from behind. However, such sensors are limited in their physical properties to stay constant tracking of the user, especially when being used in crowded places or when the lighting condition is poor.

Therefore, there exists a need for improved self-driving systems that can address the above-mentioned issues.

### SUMMARY

Embodiments of the present disclosure relates to a self-driving system. In one embodiment, the self-driving system includes a mobile base having one or more motorized wheels, the mobile base having a first end and a second end opposing the first end, one or more cameras operable to identify a target object, one or more proximity sensors operable to measure a distance between the target object and the mobile base, and a controller. The controller is configured to direct movement of the motorized wheels based on data received from the one or more cameras and one or more proximity sensors, and switch operation mode of the self-driving system from a machine-vision integrated following mode to a pure proximity-based following mode in response to changing environmental conditions so that the self-driving system autonomously and continuously follow the target object moving in a given direction, wherein data from the one or more cameras and the one or more proximity sensors are both used for following the target object in the machine-vision integrated following mode, and wherein only data from the one or more proximity sensors are used for following the target object in the pure proximity-based following mode.

In another embodiment, a self-driving system is provided. The self-driving system includes a mobile base having one or more motorized wheels, the mobile base having a first end and a second end opposing the first end, one or more cameras operable to identify a target object, one or more proximity sensors operable to generate a digital 3-D representation of the target object, and a controller. The controller is configured to switch operation mode of the self-driving system from a machine-vision integrated following mode to a pure proximity-based following mode in response to changing environmental conditions, wherein data from the one or more cameras and the one or more proximity sensors are both used for following the target object in the machine-vision integrated following mode, and wherein only data from the one or more proximity sensors are used for following the target object in the pure proximity-based following mode, identify particulars of the target object by measuring whether a distance between two adjacent portions in the 3-D digital representation falls within a pre-set range, determine if the target object is moving by calculating a difference in distance between the particulars and surroundings at different instant of time, and direct movement of the motorized wheels so that the self-driving system autonomously and continuously follow the target object moving in a given direction.

In yet another embodiment, a self-driving system is provided. The self-driving system includes a mobile base having one or more motorized wheels, the mobile base having a first end and a second end opposing the first end, one or more cameras operable to identify a target object, one or more proximity sensors operable to measure a distance between the target object and the mobile base, and a controller. The controller is configured to identify the target object by the one or more cameras under a machine-vision integrated following mode, drive the one or more motorized wheels to follow the target object based on the distance between the target object and the mobile base measured by the one or more proximity sensors, record relative location information of the target object to the mobile base constantly, and switch operation mode of the self-driving system from the machine-vision integrated following mode to a pure proximity-based following mode in response to changing environmental conditions, wherein data from the one or more cameras and the one or more proximity sensors are both used for following the target object in the machine-vision integrated following mode, and wherein only data of the latest relative location information from the one or more proximity sensors are used for following the target object in the pure proximity-based following mode.

In yet one another embodiment, a non-transitory computer-readable medium is provided. The non-transitory computer-readable medium has program instructions stored thereon that when executed by a controller cause the controller to perform a computer-implemented method of following a target object. The computer-implemented method includes operating one or more cameras disposed on a self-driving system to identify the target object, operating one or more proximity sensors disposed on the self-driving system to measure a distance between the target object and the self-driving system, directing movement of motorized wheels of a self-driving system based on data received from the one or more cameras and the one or more proximity sensors, and switching operation mode of the self-driving system from a machine-vision integrated following mode to a pure proximity-based following mode in response to changing environmental conditions so that the self-driving system autonomously and continuously follow the target object moving in a given direction, wherein data from the one or more cameras and the one or more proximity sensors are both used for following the target object in the machine-vision integrated following mode, and wherein only data from the one or more proximity sensors are used for following the target object in the pure proximity-based following mode.

### BRIEF DESCRIPTION OF THE DRAWINGS

FIG. 1 is a perspective view of a self-driving system according to one embodiment of the present disclosure.

FIG. 2 is another perspective view of the self-driving system according to one embodiment of the present disclosure.

FIG. 3 is an example of using a proximity sensor to identify the legs of an operator within a predetermined area.

FIG. 4 is a plan view of a self-driving system operated under a pure proximity-based following mode according to one embodiment of the present disclosure.

FIG. 5A illustrates an operator moving within a predetermined area.

FIG. 5B illustrates a third person in between an operator and a self-driving system.

FIG. 5C illustrates the third person moving out of the predetermined area.

FIG. 6A illustrates a self-driving system being temporarily switched from a machine-vision integrated following mode to a pure proximity-based following mode when a target object is out of sight of machine-vision cameras.

FIG. 6B illustrates a self-driving system resumes back to a machine-vision integrated following mode upon finding a target object in order to continuously follow the target object.

FIG. 7 is a block diagram of a self-driving system according to embodiments of the present disclosure.

FIG. 8A illustrates a schematic isometric back view of a self-driving system according to one embodiment.

FIG. 8B illustrates a pull rod of a luggage according to one embodiment.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

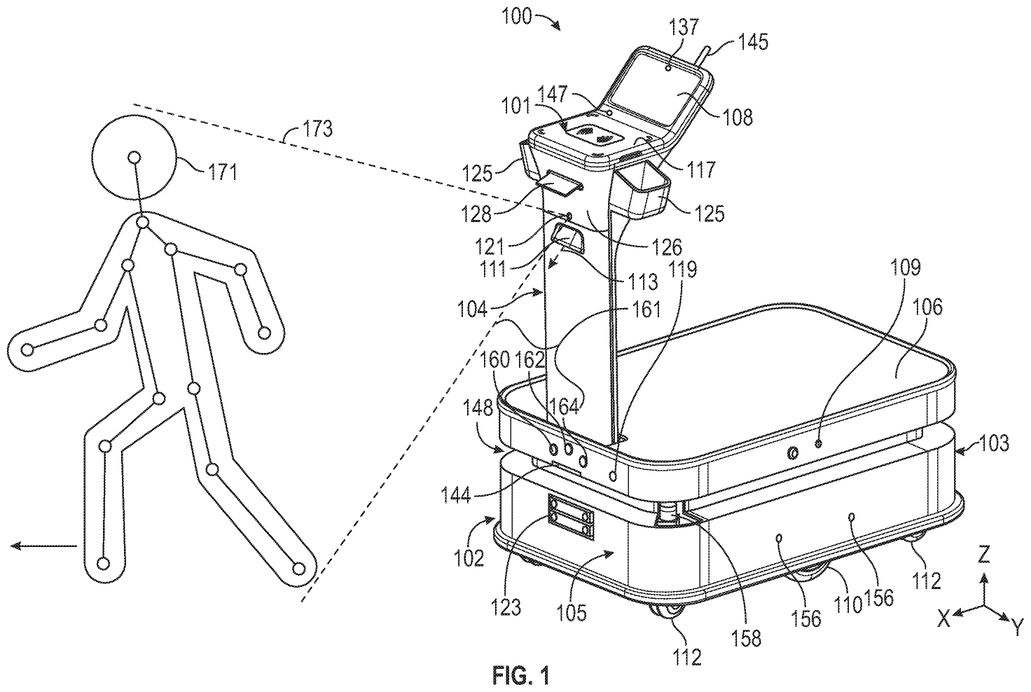

Embodiments of the present disclosure relate to self-driving systems having an advanced tracking capability. It should be understood that while the term “self-driving system” is used in this disclosure, the concept of various embodiments in this disclosure can be applied to any self-driving vehicles and mobile robots, such as autonomously-navigating mobile robots, inertially-guided robots, remote-controlled mobile robots, and robots guided by laser targeting, vision systems, or roadmaps. Various embodiments are discussed in greater detail below with respect to FIGS. 1-8B.

FIG. 1 is a perspective view of a self-driving system 100 according to one embodiment of the present disclosure. The self-driving systems can be used as package carriers in various operating systems, such as warehouses, hospitals, airports, and other environments that may use automated package transportation. The self-driving system 100 generally includes a mobile base 102 and a console 104. The mobile base 102 has a rear end 103 and a front end 105 opposing the rear end 103. The console 104 is coupled to the top of the mobile base 102 near the front end 105 in a standing or upright configuration. In some embodiments, the mobile base can move up and down vertically using one or more actuators (not shown) embedded inside the mobile base 102.

The self-driving system 100 is capable of moving autonomously between designated areas within a facility based on pre-stored commands, maps, or instructions received from a remote server. The remote server may include a warehouse management system that can wireless communicate with the self-driving system 100. The mobility of the self-driving system 100 is achieved through a motor that connects to one or more motorized wheels 110 and a plurality of stabilizing wheels 112. Each of the motorized wheels 110 is configured to rotate and/or roll in any given direction to move the self-driving system 100. For example, the motorized wheels 110 can rotate about the Z-axis and roll forward or backward on the ground about its axle spindle along any directions, such as along the X-axis or along the Y-axis. The motorized wheels 110 may be controlled to roll at different speed. The stabilizing wheels 112 may be caster-type wheels. In some embodiments, any or all of the stabilizing wheels 112 may be motorized. In this disclosure, moving forward refers to the situation when the front end 105 is the leading end and moving backward refers to the situation when the rear end 103 is the leading end.

A display 108 is coupled to the top of the console 104 and configured to display information. The display 108 can be any suitable user input device for providing information associated with operation tasks, map of the facility, routing information, inventory information, and inventory storage, etc. The display 108 also allows an operator to manually control the operation of the self-driving system 100. If manual use of the self-driving system is desired, the operator can override the automatic operation of the self-driving system 100 by entering updated commands via the display 108.

The self-driving system 100 may have one or more emergency stop buttons 119 configured to stop a moving self-driving system when pressed. The self-driving system 100 also has a pause/resume button 147 configured to pause and resume the operation of the self-driving system 100 when pressed. The emergency stop button 119 may be disposed at the mobile base 102 or the console 104. The pause/resume button 147 may be disposed at the mobile base 102 or the console 104, such as at the front side of the display 108.

A charging pad 123 can be provided at the front end 105 and/or rear end 103 of the mobile base 102 to allow automatic charging of the self-driving system 100 upon docking of the self-driving system 100 with respect to a charging station (not shown).

In some embodiments, the console 104 is integrated with a RFID reader 101. The RFID reader 101 can be disposed at the console 104. The RFID reader 101 has a sensor surface 117 facing upwardly to interrogate the presence of items placed on, over, or directly over the sensor surface 117 by wirelessly detecting and reading RFID tags attached to each item.

The self-driving system 100 may include a printer 126 which may be disposed inside the console 104. The printer is responsive to the RFID tags scanned by the RFID reader 101 for printing a label. The printer can also communicate with the remote server to receive and/or print additional information associated with the item. The label is printed through a paper discharge port 128, which may be located at the front end 105 of the console 104. One or more baskets 125 can be provided to the console 104 of the self-driving system 100 to help the operator store tools needed for packing.

The self-driving system 100 has a positioning device 145 coupled to the console 104. The positioning device 145 is configured to communicate information regarding position of the self-driving system 100 to the remote server. The positioning device 145 can be controlled by a circuit board, which includes at least a communication device, disposed in the console 104. The position information may be sent to the communication device wirelessly over an internet, through a wired connection, or using any suitable manner to communicate with the remote server. Examples of wireless communication may include, but are not limited to, ultra-wideband (UWB), radio frequency identification (active and/or passive), Bluetooth, WiFi, and/or any other suitable form of communication using IoT technology.

In one embodiment, the positioning device 145 is an UWB based device. Ultra-wideband described in this disclosure refers to a radio wave technology that uses low energy for short-range, high-bandwidth communications over a large portion of the radio spectrum, which includes frequencies within a range of 3 hertz to 3,000 gigahertz. The positioning device 145 may have three antennas (not shown) configured to receive signals (such as a radio frequency wave) from one or more UWB tags that can be placed at various locations of the facility, such as on the storage rack or building poles of a warehouse. The signal is communicated by a transmitter of the UWB tags to the positioning device 145 to determine the position of the self-driving system 100 relative to the UWB tags. As a result, the precise position of the self-driving system 100 can be determined.

The self-driving system 100 includes a plurality of cameras and sensors that are configured to help the self-driving system 100 autonomously and continuously follow any type of object, such as an operator or a vehicle moving in a given direction. In various embodiments, one or more cameras and/or sensors are used to capture and identify images and/or videos of the object, and one or more sensors are used to calculate the distance between the object and the self-driving system 100. The data received from the cameras and the sensors are used to direct movement of the self-driving system 100. In one embodiment, the self-driving system 100 is configured to follow an operator from behind. In one embodiment, the self-driving system 100 is configured to follow along the side of an operator in a given direction within a predetermined distance detected by the self-driving system 100. In one embodiment, the self-driving system 100 can move in a forward direction that is different from a head direction of the self-driving system 100. In some embodiments, the self-driving system 100 is configured to follow along the side of an operator, transition to a follow position behind the operator to avoid an obstacle, and then transition back to the side follow position next to the operator.

In one embodiment, which can be combined with any other embodiments discussed in this disclosure, the self-driving system 100 is operated under an object recognition mode and directed to follow an object using one or more cameras to recognize an object. The one or more cameras may be a machine-vision camera that can recognize the object, identify movement/gestures of the object, and optionally detect distance with respect to the object, etc. An exemplary machine-vision camera is a Red, Green, Blue plus Depth (RGB-D) camera that can generate three-dimensional images (a two-dimensional image in a plane plus a depth diagram image). Such RGB-D cameras may have two different groups of sensors. One of the groups includes optical receiving sensors (such as RGB cameras), which are used for receiving images that are represented with respective strength values of three colors: R (red), G (green) and B (blue). The other group of sensors includes infrared lasers or light sensors for detecting a distance (or depth) (D) of an object being tracked and for acquiring a depth diagram image. Other machine-vision cameras such as a monocular camera, a binocular camera, a stereo camera, a camera that uses Time-of-Flight (ToF) technique based on speed of light for resolving the distance from an object, or any combination thereof, may also be used.

In any cases, the machine-vision cameras are used to at least detect the object, capture the image of the object, and identify the characteristics of the object. Exemplary characteristics may include, but are not limited to, facial features of an operator, a shape of the operator, bone structures of the operator, a pose/gesture of the operator, the clothing of the operator, or any combination thereof. The data obtained by the machine-vision cameras are calculated by a controller located within the self-driving system 100 and/or at the remote server. The calculated data can be used to direct the self-driving system 100 to follow the object in any given direction, while maintaining a pre-determined distance with the object. The machine-vision cameras can also be used to scan the marker/QR codes/barcodes of an item to confirm if the item is the correct item outlined in a purchase order or a task instruction.

The machine-vision cameras discussed herein may be disposed at any suitable locations of the self-driving system 100. In some embodiments, the machine-vision cameras are coupled to one of four sides of the console 104 and/or the mobile base 102 and facing outwards from the self-driving system 100. In some embodiments, one or more machine-vision cameras are disposed at the console 104. For example, the self-driving system 100 can have a first machine-vision camera 121 disposed at the console 104. The first machine-vision camera 121 may be a front facing camera.

In some embodiments, one or more machine-vision cameras are disposed at the mobile base 102. For example, the self-driving system 100 can have cameras 160, 162, 164 disposed at the front end 105 of the mobile base 102 and configured as a second machine-vision camera 161 for the self-driving system 100. The second machine-vision camera 161 may be a front facing camera. The self-driving system 100 can have a third machine-vision camera 109 disposed at the opposing sides of the mobile base 102, respectively. The self-driving system 100 can have cameras 166, 168 disposed at the rear end 103 of the mobile base 102 and configured as a fourth machine-vision camera 165 for the self-driving system 100. The fourth machine-vision camera 165 may be a rear facing camera.

In some embodiments, which can be combined with any embodiment discussed in this disclosure, one or more machine-vision cameras may be disposed at the front side and/or back side of the display 108. For example, the self-driving system 100 can have a fifth machine-vision camera 137 disposed at the front side of the display 108.

The first, second, and fifth machine-vision cameras 121, 161, 137 may be oriented to face away from the rear end 103 of the self-driving system 100. If desired, the first and/or fifth machine-vision cameras 121, 137 can be configured as a people/object recognition camera for identifying the operator and/or the items with a marker/QR codes/barcodes. FIG. 1 shows an example where the first machine-vision camera 121 is used to capture an operator 171 and recognizes characteristics of the operator 171. The operator 171 is within a line of sight 173 of the first machine-vision camera 121. The first machine-vision camera 121 captures a full body image (or video) of the operator 171 and identify the operator 171 using the characteristics discussed above, such as facial features and bone structures, for purpose of following the operator 171.

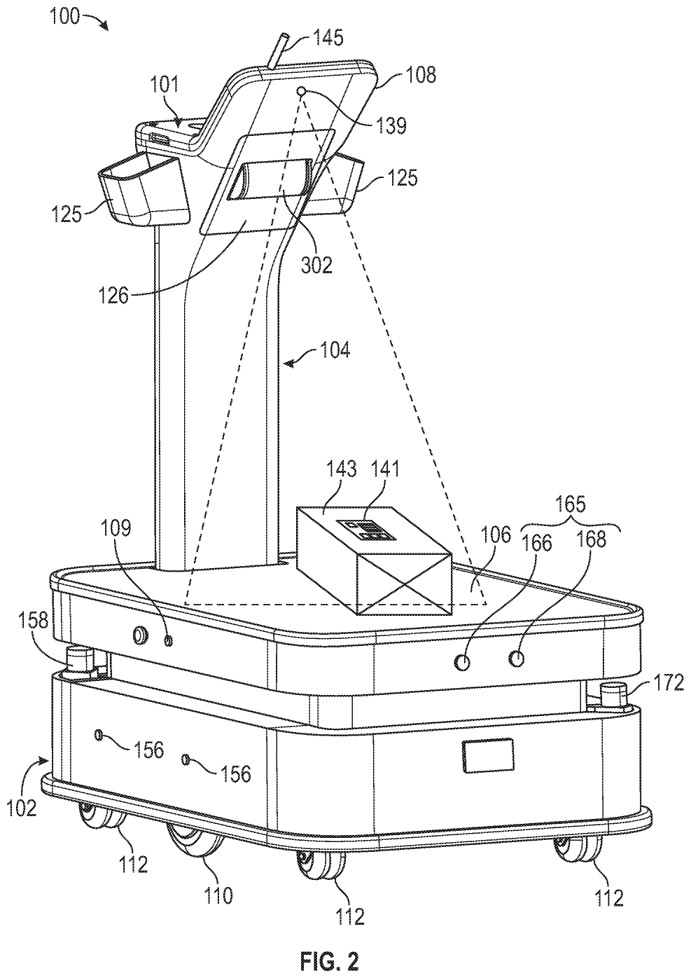

In some embodiments, which can be combined with any embodiment discussed in this disclosure, a general-purpose camera 139 may be disposed at the back side of the display 108 and configured to read marker/QR codes/barcodes 141 of an item 143 disposed on an upper surface 106 of the mobile base 102, as shown in FIG. 2. The general-purpose camera 139 can also be configured to identify the operator. Alternatively, the general-purpose camera 139 can be replaced with the machine-vision camera discussed herein. It is understood that more or less general-purpose camera and machine-vision cameras can be coupled to the self-driving system 100 and should not be limited to the number and/or location shown in the drawings. Any of the machine-vision cameras may also be replaced with a general-purpose camera, depending on the application.

Additionally or alternatively, the self-driving system 100 can be operated under a pure proximity-based following mode and directed to follow the object using one or more proximity sensors. The one or more proximity sensors can measure the distance between the object and a portion of the self-driving system 100 (e.g., mobile base 102) for the purposes of following the object. The one or more proximity sensors can also be used for obstacle avoidance. The data obtained by the one or more proximity sensors are calculated by the controller located within the self-driving system 100 and/or at the remote server. The calculated data can be used to direct the self-driving system 100 to follow the object in any given direction, while maintaining a pre-determined distance with the object. The one or more proximity sensors may be a LiDAR (Light Detection and Ranging) sensor, a sonar sensor, an ultrasonic sensor, an infrared sensor, a radar sensor, a sensor that uses light and laser, or any combination thereof. In various embodiments of the disclosure, a LiDAR sensor is used for the proximity sensor for the self-driving system 100.

The proximity sensors discussed herein may be disposed at any suitable locations of the self-driving system 100. For example, the one or more proximity sensors are disposed at a cutout 148 of the mobile base 102. The cutout 148 may extend around and inwardly from a peripheral edge of the mobile base 102. In one embodiment shown in FIG. 2, the self-driving system 100 has a first proximity sensor 158 and a second proximity sensor 172 disposed at diagonally opposite corners of the mobile base 102, respectively. Since each proximity sensor 158, 172 can be configured to sense a field of view greater about 90 degrees, for example about 270 degrees, the extension of the cutout 148 allows the proximity sensors 158, 172 to provide greater sensing area for the self-driving system 100. If desired, four corners of the mobile base 102 can be equipped with the proximity sensors.

For effective capture of other object/obstacle that may present along the route of traveling, such as operator's feet, pallets, or other low-profile objects, the self-driving system 100 may further include a depth image sensing camera 111 that is pointed forward and down (e.g., a down-forward facing camera). In one embodiment, the depth image sensing camera 111 points to a direction 113 that is at an angle with respect to the longitudinal direction of the console 104. The angle may be in a range from about 30 degrees to about 85 degrees, such as about 35 degrees to about 65 degrees, for example about 45 degrees.

The combination of the information recorded, detected, and/or measured by the machine-vision cameras 109, 121, 137, 161, 165 and/or proximity sensors 158, 172 are used to move the self-driving system 100 in a given direction with an operator while avoiding nearby obstacles, and autonomously maintain the self-driving system 100 in a front, rear, or side follow position to the operator. Embodiments of the self-driving system 100 can include any combination, number, and/or location of the machine-vision cameras and the proximity sensors coupled to the mobile base 102 and/or the console 104, depending on the application.

In most cases, the self-driving system 100 is operated under a “machine-vision integrated following mode” in which the machine-vision cameras and the proximity sensors are operated concurrently. That is, the self-driving system 100 is operated under the “object recognition mode” and the “pure proximity-based following mode” simultaneously when following the object. If one or more machine-vision cameras are partially or fully blocked (e.g., by another object that is moving in between the target object and the self-driving system 100), or when the self-driving system 100 follows the object in low ambient light conditions, the input data transmitted from the one or more machine-vision cameras, or all machine-vision cameras (e.g., machine-vision cameras 109, 121, 137, 161, 165) may be ignored or not processed by the controller and the self-driving system 100 is switched from the machine-vision integrated following mode to the pure proximity-based following mode which follows the object using only data from the one or more proximity sensors (e.g., proximity sensors 158, 172).

Additionally or alternatively, if the images/videos captured by one or more machine-vision cameras, or all machine-vision cameras (e.g., machine-vision cameras 109, 121, 137, 161, 165), contain a single color block that is more than about 60% or above, for example about 80% to about 100%, of the surface area of the captured image, the controller can ignore or not process the input data from the one or more machine-vision cameras. In such a case, the self-driving system 100 is switched from the machine-vision integrated following mode to the pure proximity-based following mode which follows the object using only data from the one or more proximity sensors (e.g., proximity sensors 158, 172).

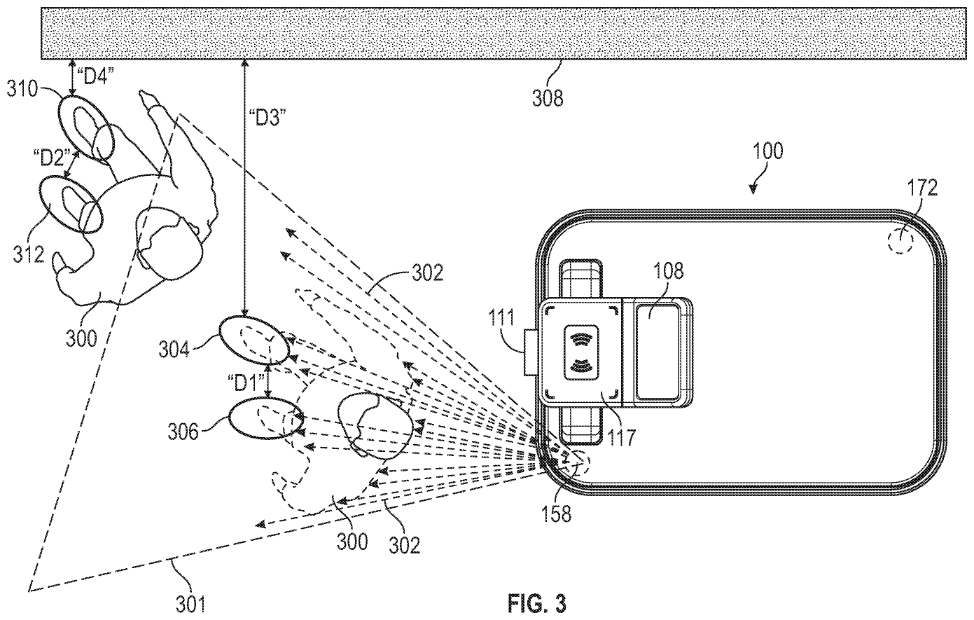

When the self-driving system 100 is operated under the pure proximity-based following mode, the proximity sensors can be configured to identify particulars of the object, such as legs of an operator, for the purpose of following the object. FIG. 3 illustrates an example where a proximity sensor (e.g., the proximity sensor 158) is used to identify the legs of an operator 300 within a predetermined area 301. The predetermined area 301 is a region that can be detected by the proximity sensor 158 and can be adjusted (e.g., increased or decreased) as desired by the operator 300 before, during, and/or after operation of the self-driving system 100. When the operator 300 walks on two feet, there is naturally a distance between the right leg and the left leg. Such a distance can be used to help the proximity sensor 158 identify the legs of the operator 300. For example, the proximity sensor 158 can measure distance to the operator 300 by scanning or illuminating the operator 300 with a plurality of laser lights 302 and measuring the reflected lights with the proximity sensor 158. The differences in laser return times can then be used to make a digital 3-D representation of the operator 300. If the distance “D1” between two adjacent portions falls within a pre-set range, the proximity sensor 158 will consider that two adjacent portions as the legs of the operator 300 and may represent the legs as two columns 304, 306. The pre-set range described in this disclosure refers to a range from a minimum distance between two legs that are closer together to the maximum distance between two legs that are spread open or apart. It is contemplated that the pre-set range may vary depending on the particulars of the object selected by the operator and/or the remote server.

Once the legs (i.e., columns 304, 306) are identified, the proximity sensor 158 may detect the movement of the legs by calculating the difference in distance between the columns 304, 306 and the surroundings (e.g., a storage rack 308) at different instant of time. For example, the operator 300 may walk from a first location that is away from the storage rack 308 to a second location that is closer to the storage rack 308. The proximity sensor 158 can identify columns 310, 312 as legs of the operator 300 due to the distance “D2” between columns 310, 312 falls within the pre-set range. The proximity sensor 158 can also determine whether the operator 300 is moving based on the distances “D3” and “D4” between the storage rack 308 and the columns 304, 306 and columns 310, 312, respectively, at different times. The self-driving system 100 can use the information obtained from the proximity sensor 158 to identify the operator, determine whether to follow the operator 300 and/or maintain a pre-determined distance with the operator 300.

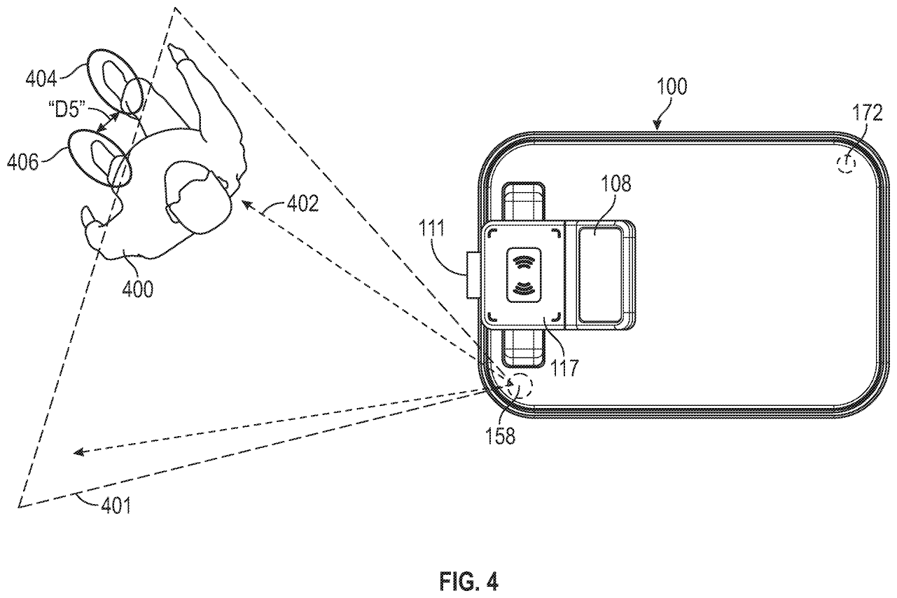

FIG. 4 is a top view of the self-driving system 100 operated under the pure proximity-based following mode (with or without the machine-vision cameras being turned on), and showing an operator 400 near or at least partially outside of the boundary of the predetermined area 401 as detected by a proximity sensor ((e.g., the proximity sensor 158) according to one embodiment. Likewise, the predetermined area 401 is a region that can be detected by the proximity sensor 158 and can be adjusted (e.g., increased or decreased) as desired by the operator 400 before, during, and/or after operation of the self-driving system 100. In this embodiment, particulars of the operator 400 have been detected and identified as legs to be tracked because the distance “D5” between the columns 404, 406 falls within the pre-set range. When the self-driving system 100 detects that the operator 400 is near or at least partially outside the predetermined area 401, the motorized wheels (e.g., motorized wheels 110) are directed to speed up and move the self-driving system 100 faster to keep the operator 400 within the predetermined area 401. Similarly, when the self-driving system 100 detects that the operator 400 is within the predetermined area 401 and being too close to the self-driving system 100, the motorized wheels are directed to slow down so that the self-driving system 100 is maintained at pre-determined distance with the operator 400.

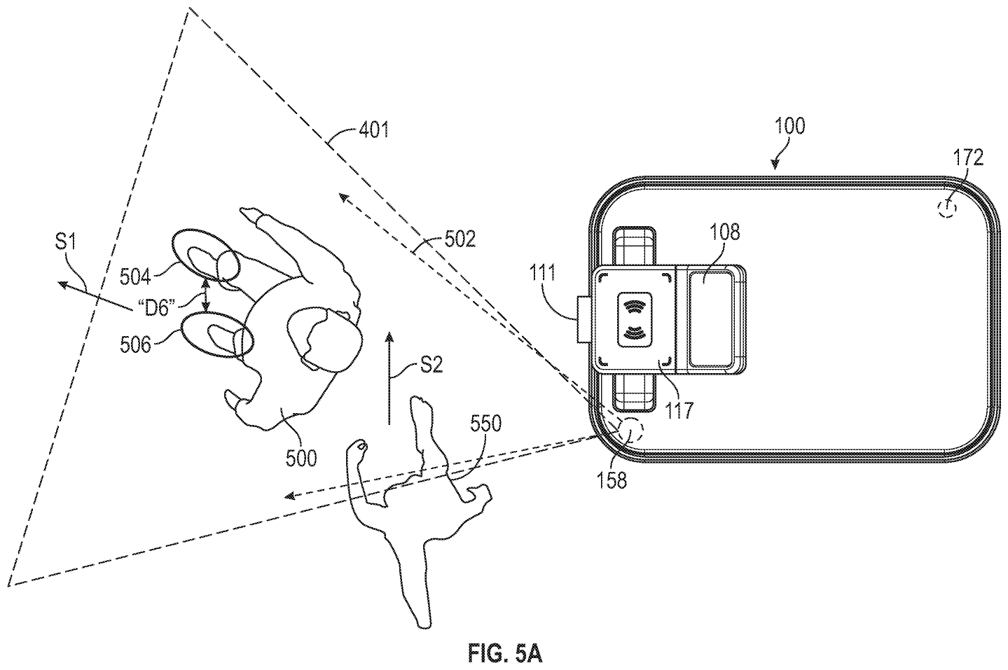

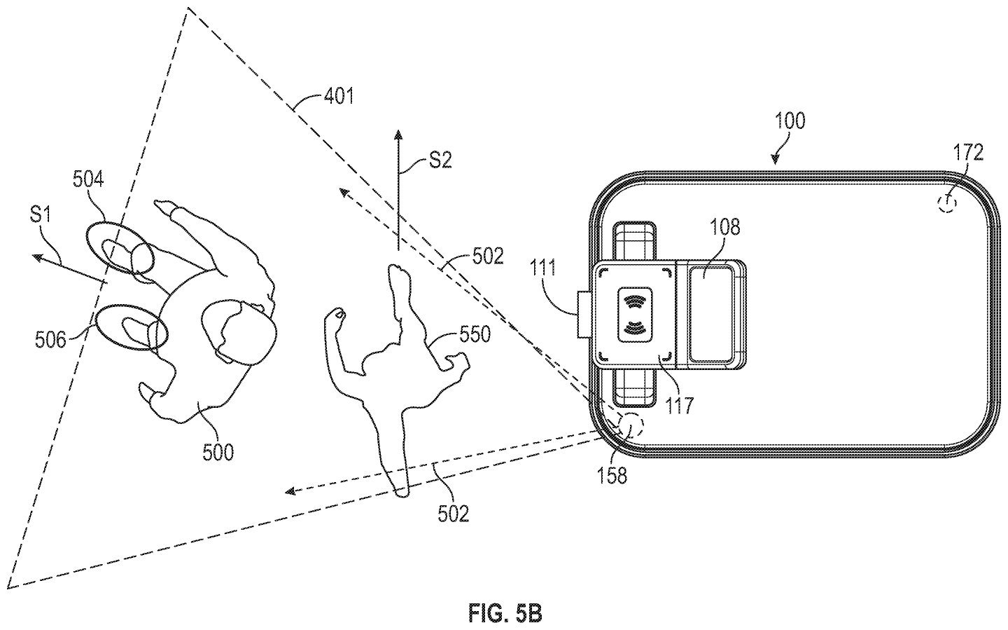

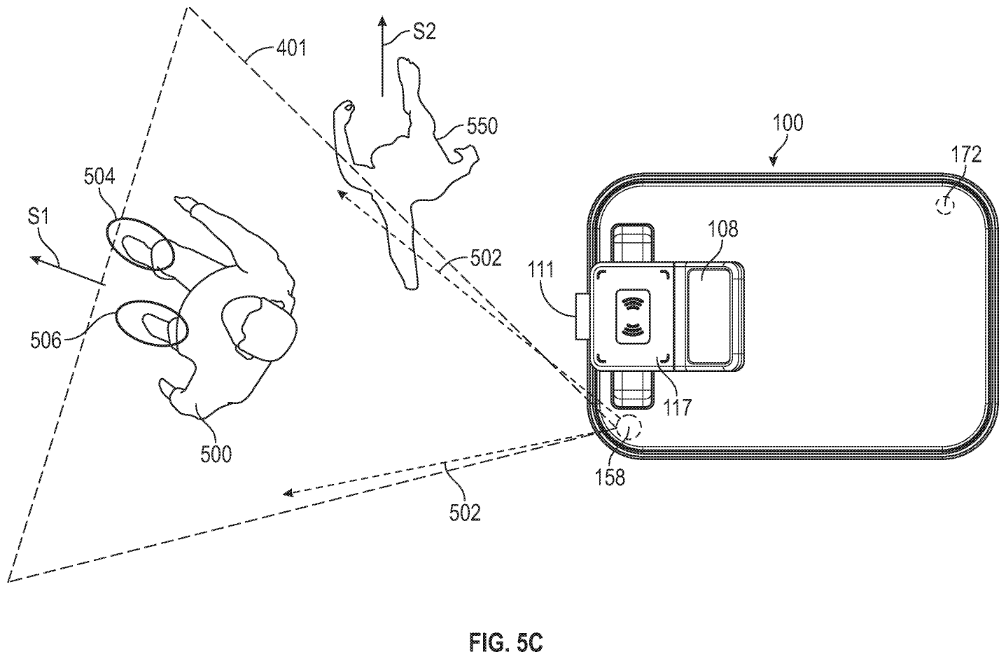

Numerous approaches may be taken to further improve the tracking accuracy of the self-driving system 100 operated under the pure proximity-based following mode. In one embodiment, the self-driving system 100 can be configured to remember the speed of the object being tracked. FIGS. 5A-5C illustrate a sequence of operation of the self-driving system 100 showing another moving object in the form of a third person 550 moving in-between an operator 500 and the self-driving system 100 within a predetermined area 501. Likewise, the predetermined area 501 is a region that can be detected by the proximity sensor 158 and can be adjusted (e.g., increased or decreased) as desired by the operator 500 before, during, and/or after operation of the self-driving system 100. In addition, particulars of the operator 500 have been scanned by a plurality of laser lights 502 and identified as legs to be tracked because the distance “D6” between the columns 504, 506 falls within the pre-set range. The self-driving system 100 is configured to continuously monitor, measure, and store the speed of the operator 500 during operation. In the event that the third person 550 enters the predetermined area 501 and moves in-between the operator 500 and the self-driving system 100, the self-driving system 100 will move and follow the operator 500 at the stored speed instead of the speed of the third person 550.

FIG. 5A illustrates operator 500 moving at a speed S1 and is within the predetermined area 501. The self-driving system 100 will continuously monitor and measure the speed S1 of the operator 500. The third person 550 is shown approaching and entering the predetermined area 501 at a position between the operator 500 and the self-driving system 100 and moving at a speed S2. The speed S2 is different than (e.g., greater than or less than) the speed S1.

FIG. 5B illustrates the third person 550 in between the operator 500 and the self-driving system 100. The self-driving system 100 is configured to detect the third person 550 and the speed S2 at which the third person is moving. When the third person 550 at least partially or fully blocks the proximity sensor 158 from detecting the operator 500, the self-driving system 100 is configured to keep moving at the previously measured and stored speed S1 of the operator 500.

FIG. 5C illustrates the third person 550 moving out of the predetermined area 501 such that the proximity sensor 158 is able to detect the operator 500 moving at the speed S1 again. The self-driving system 100 is continuously directed to move in the given direction and maintain the pre-determined distance with the operator 500.

In another embodiment, which can be combined with any other embodiments discussed in this disclosure, the proximity sensor (e.g., proximity sensor 158) can be configured to track an object that is the closest to the self-driving system 100 and has particulars (e.g., legs of an operator) identified using the technique discussed above, thereby improving the tracking accuracy of the self-driving system 100 operated under the pure proximity-based following mode.

In one another embodiment, which can be combined with any other embodiments discussed in this disclosure, the proximity sensor (e.g., proximity sensor 158) can be configured to track an object based on the most recent or latest relative location information obtained using the technique discussed above, thereby improving the tracking accuracy of the self-driving system 100 operated under the pure proximity-based following mode. The relative location information can be obtained by measuring the distance between the object and the self-driving system 100 using the proximity sensor and recording relative location information of the object to the self-driving system 100. The relative location information may be stored in the self-driving system 100 and/or the remote server.

In yet another embodiment, which can be combined with any other embodiments discussed in this disclosure, while the self-driving system 100 is performed under “object recognition mode” and “pure proximity-based following mode” (collectively referred to as the machine-vision integrated following mode), identifiable characteristics associated with the object can be monitored using the machine-vision cameras and proximity sensors discussed above. The identified information is stored in the self-driving system 100 and/or the remote server and can be used to continuously identify the object when one or more machine-vision cameras are blocked. Identifiable characteristics may include, but are not limited to, one or more of the following: pre-set range of a distance between legs, reflective characteristics of skin and clothing, spatial factors of walking such as step length, stride length (the distance between two heel contacts from the same foot), and step width, temporal factors of walking such as double support time (the duration of the stride when both feet are on the ground at the same time) and cadence (step frequency), or any combination thereof.

When one or more machine-vision cameras are blocked, either partially or fully (e.g., by another object that is moving in between the target object and the self-driving system 100), or when the self-driving system 100 follows the object in low ambient light conditions, the self-driving system 100 can switch from the machine-vision integrated following mode to the pure proximity-based following mode and use the monitored/stored identifiable characteristics to identify the correct object to follow. In some cases, the self-driving system 100 may switch from the machine-vision integrated following mode to the pure proximity-based following mode and continuously follow the object that has the most identifiable characteristics matched the identifiable information stored in the self-driving system 100 or the remote server. This technique can effectively identify the correct object to follow, especially when the self-driving system 100 is operated in crowed places, such as a warehouse where two or more operators may work at the same station or present along the route of traveling.

In any of the embodiments where the self-driving system 100 is performed under the pure proximity-based following mode, one or more machine-vision cameras may remain on to assist identification of the object. The one or more machine-vision cameras may be programmed to switch off when they are partially or fully blocked for more than a pre-determined period of time, such as about 3 seconds to about 40 seconds, for example about 5 seconds to about 20 seconds.

In some embodiments, which can be combined with any other embodiments discussed in this disclosure, the self-driving system 100 may temporarily switch from the machine-vision integrated following mode to pure proximity-based following mode when the target object is out of sight of the one or more machine-vision cameras or outside a predetermined area (the area that can be detected by the machine-vision cameras). In such a case, the proximity sensors (e.g., LiDAR sensor) remain on to continuously identify and follow the target object, while input data transmitted from the machine-vision cameras are ignored or not processed by the controller to prevent the self-driving system 100 from swaying left and right searching for the target object, which leads to a possible fall of off the loads from the self-driving system 100. The proximity sensors 158, 172 (e.g., LiDAR sensor) and the cutout 148 allow the self-driving system 100 to provide at least 270 degrees or greater of sensing area.

In some embodiments, which can be combined with any other embodiments discussed in this disclosure, the self-driving system 100 may temporarily switch from the machine-vision integrated following mode to pure proximity-based following mode if the machine-vision cameras cannot detect the target object for a pre-determined period of time, such as about 1 second to about 30 seconds, for example about 2 seconds to about 20 seconds.

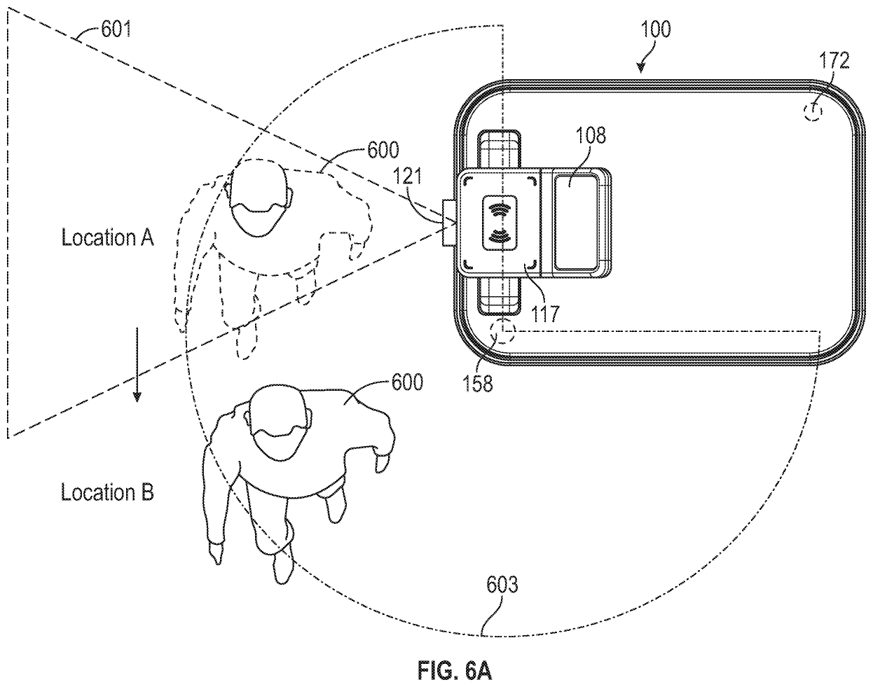

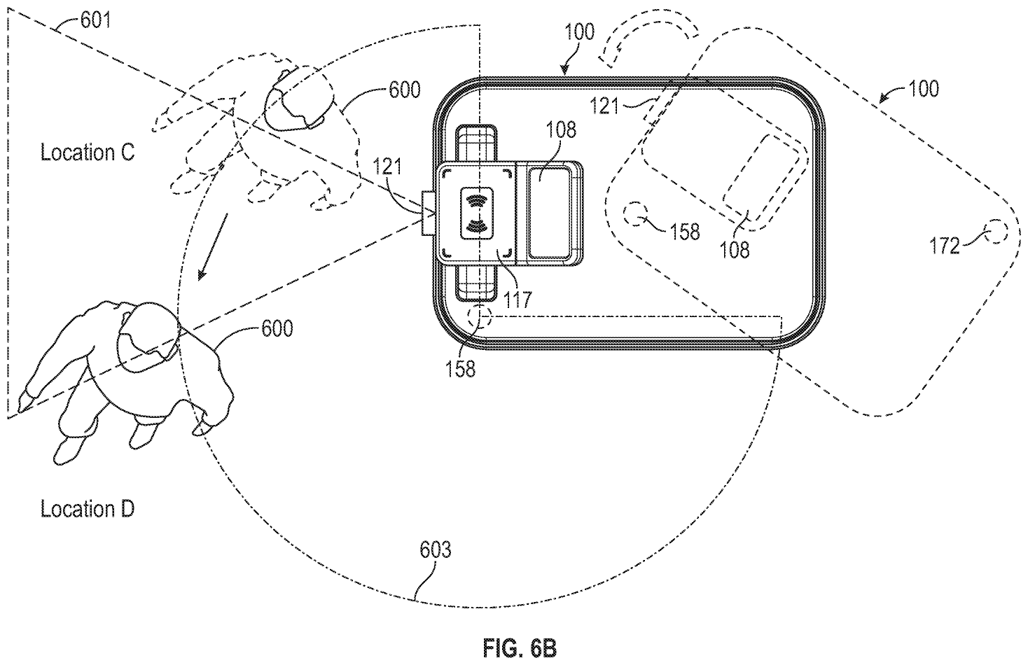

In some embodiments shown in FIG. 6A, which can be combined with any other embodiments discussed in this disclosure, the self-driving system 100 may temporarily switch from the machine-vision integrated following mode to pure proximity-based following mode if the target object 600 is out of sight of the one or more machine-vision cameras (e.g., the first machine-vision camera 121). That is, the self-driving system 100 may temporarily switch to the pure proximity-based following mode if the target object 600 moves from a Location A to a Location B that is not within the predetermined area 601 of the machine-vision camera 121. The predetermined area 601 is the area that can be detected by the machine-vision camera 121. The self-driving system 100 will then determine if the target object 600 becomes detectable. For example, the object 600 can still be detected by the proximity sensors 158 (e.g., within the predetermined area 603 that can be detected by the proximity sensor 158), or if the object 600 returns to the route that was previously recorded before switching to the pure proximity-based following mode, e.g., returning from Location B to Location A. If the target object 600 become detectable, the self-driving system 100 may switch back to the machine-vision integrated following mode in which both machine-vision cameras (e.g., the first machine-vision camera 121) and proximity sensors (e.g., the proximity sensor 158) are used for following the target object. Since the object 600 is almost seamlessly monitored by at least one or more proximity sensors (e.g., the proximity sensor 158), the self-driving system 100 does not need to sway and search for the object 600 just because the machine-vision camera (e.g., the first machine-vision camera 121) had temporarily lost tracking of the object 600. Therefore, any potential fall of off the loads from the self-driving system 100 due to swaying of the self-driving system 100 can be avoided.

In some embodiments shown in FIG. 6B, which can be combined with any other embodiments discussed in this disclosure, in the event that the target object 600 moves from Location C to Location D, the self-driving system 100 is configured to not actively search for the target object 600 until any one or more of the following occurs: (1) the proximity sensor (e.g., the proximity sensor 158) lose track of the target object 600; (2) the target object 600 is outside the predetermined area 603; (3) the target object 600 is away from the self-driving system 100 over a pre-determined distance; or (4) both machine-vision cameras (e.g., the first machine-vision camera 121) and the proximity sensors (e.g., the proximity sensor 158) lost the target object 600. Once the self-driving system 100 finds the target object 600, the self-driving system 100 may resume the machine-vision integrated following mode, or any suitable following technique to continuously follow the target object 600.

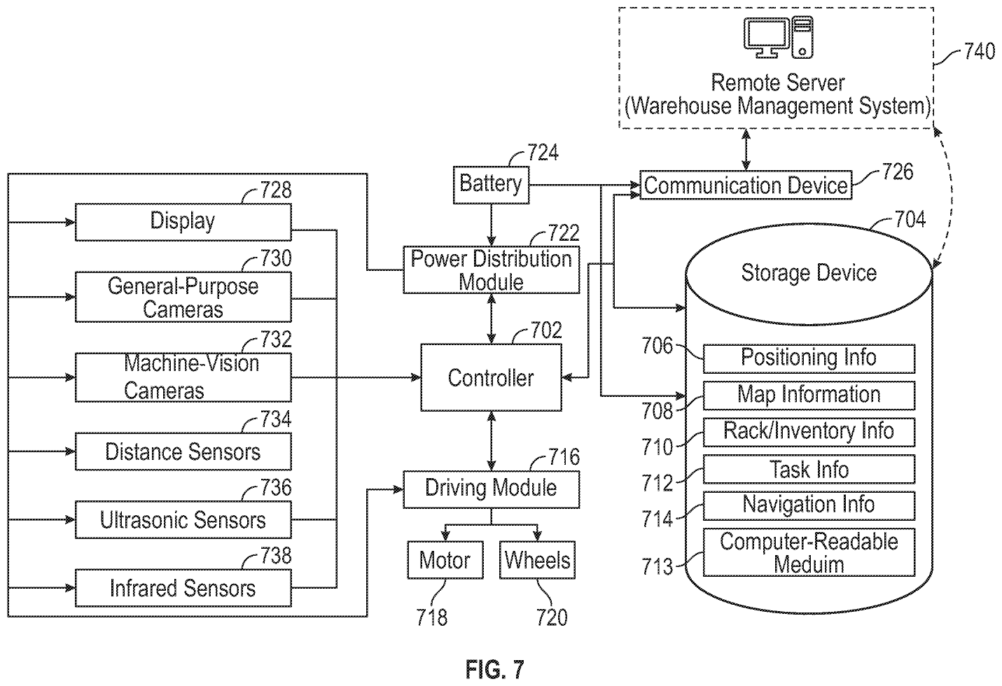

FIG. 7 is a block diagram of the self-driving system 100 according to embodiments of the present disclosure. The self-driving system 100 includes a controller 702 configured to control various operations of the self-driving system 100, which may include any one or more embodiments discussed in this disclosure or any type of task needed using the self-driving system 100. The controller 702 can be a programmable central processing unit (CPU) or any suitable processor that is operable to execute program instructions (“software”) stored in a computer-readable medium 713. The computer-readable medium 713 may be stored in a storage device 704 and/or a remote server 740. The computer-readable medium 713 may be a non-transitory computer-readable medium such as a read-only memory, a RAM, a magnetic or optical disk, or a magnetic tape. The controller 702 is in communication with the storage device 704 containing the computer-readable medium 713 and data such as positioning information 706, map information 708, storage rack/inventory information 710, task information 712, and navigation information 714, for performing various operations discussed in this disclosure.

The positioning information 706 contains information regarding position of the self-driving system 100, which may be determined using a positioning device (e.g., the positioning device 145) disposed at the self-driving system 100. The map information 708 contains information regarding the map of the facility or warehouse. The storage rack/inventory information 710 contains information regarding the location of the storage rack and inventory. The task information 712 contains information regarding the task to be performed, such as order instruction and destination information (e.g., shipping address). The navigation information 714 contains information regarding routing directions to be provided to the self-driving system 100 and/or a remote server 740, which may be a warehouse management system. The navigation information 714 can calculate one or more information from the positioning information 706, the map information 708, the storage rack/inventory information 710, and the task information 712 to determine the best route for the self-driving system 100.

The controller 702 can transmit to, or receive information/instructions from, the remote server 740 through a communication device 726 that is disposed at or coupled to a positioning device (e.g., the positioning device 145). The controller 702 is also in communication with several modules to direct movement of the self-driving system 100. Exemplary modules may include a driving module 716, which controls a motor 718 and motorized wheels 720, and a power distribution module 722, which controls distribution of the power from a battery 724 to the controller 702, the driving module 716, the storage device 704, and various components of the self-driving system 100, such as the communication device 726, a display 728, cameras 730, 732, and sensors 734, 736, 738.

The controller 702 is configured to receive data from general-purpose cameras 730 (e.g., general-purpose camera 139) and machine-vision cameras 732 (e.g., machine-vision cameras 109, 121, 137, 161, 165) that are used to recognize the object, identify movement/gestures of the object, and detect distance with respect to the object. The controller 702 is also configured to receive data from proximity sensors 734, ultrasonic sensors 736, and infrared sensors 738 (e.g., proximity sensors 158, 172), that are used to measure the distance between the object and the self-driving system 100. The controller 702 can analyze/calculate data received from the storage device 704 as well as any task instructions (either from the remote server 740 or entered by the operator via the display 728) to direct the self-driving system 100 to constantly follow the target object under machine-vision integrated following mode and/or pure proximity-based following mode discussed above with respect to FIGS. 3-6B. The general-purpose cameras 730 and/or machine-vision cameras 732 can also be used to read markers/QR codes to help determine the position of the self-driving system 100 or read barcodes of an item.

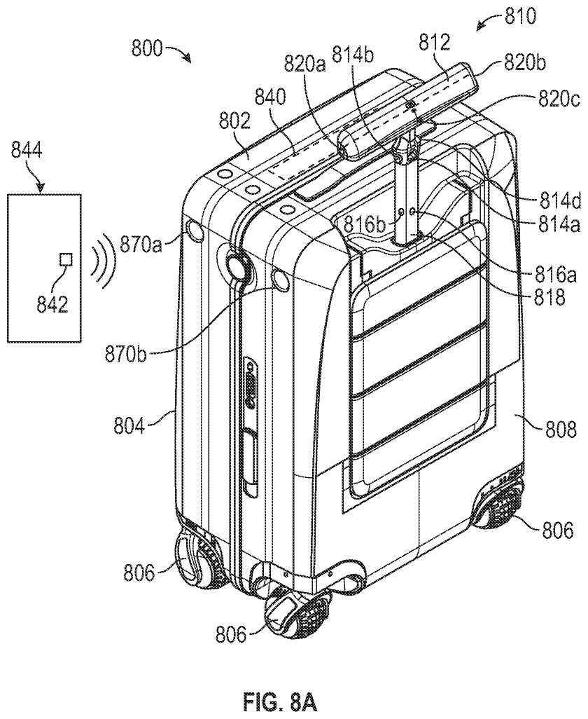

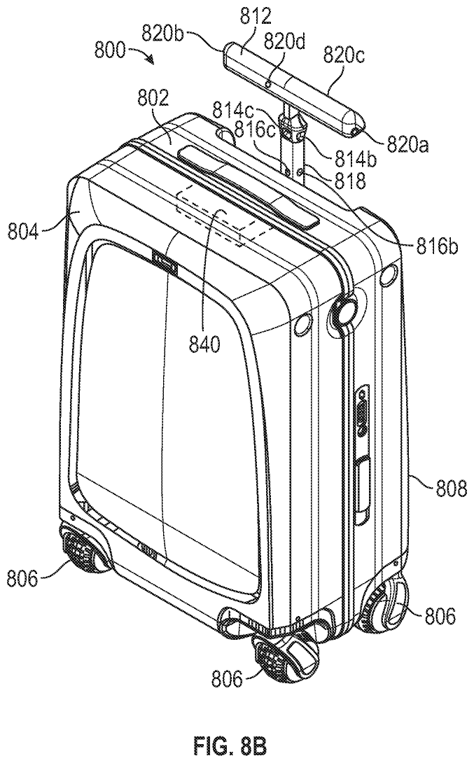

While embodiments of the self-driving systems are described and illustrated with respect to Autonomous Mobile Robots (ARMs), the concept of various embodiments discussed above may also be applied to other types of self-driving system or portable equipment, such as an autonomous luggage system having multiple following modes. FIG. 8A illustrates a schematic isometric back view of a self-driving system 800 according to one embodiment. The self-driving system 800 may be a smart luggage system. The self-driving system 800 includes a body in the form of a piece of luggage 802. The piece of luggage 802 may be a suitcase or travel case configured to store items and transport items. The self-driving system 800 includes one or more motorized wheels 806 coupled to the bottom of the piece of luggage 802. Each motorized wheel 806 rotates and rolls in a given direction. In one example, the luggage 802 is supported by two, three, four, or more motorized wheels, each configured to move the piece of luggage 802 in a given direction.

The self-driving system 800 includes an onboard ultra-wideband (“UWB”) device 840 disposed on the piece of luggage 802. The onboard UWB device 840 can continuously communicate with a transmitter 842 of a mobile ultra-wideband device 844 to determine the position of a user relative to the luggage 802. The mobile ultra-wideband device 844 may be a user-wearable belt clip device, a cellular phone, a tablet, a computer, and/or any other device that can communicate with the onboard UWB device 840.

The self-driving system 800 includes a handle 810 coupled to the piece of luggage 802. The handle 810 is configured to allow a user of the self-driving system 800 to move, push, pull, and/or lift the piece of luggage 802. The handle 810 is located on a back side 808 of the luggage 802, but can be located on any side of the piece of luggage 802, such as on a front side 804 that opposes the back side 808. The handle 810 includes a pull rod 812 coupled to a connecting rod 818, which is coupled to the luggage 802. The pull rod 812 forms a “T” shape with, and telescopes within, the connecting rod 818.

The self-driving system 800 has cameras 820a, 820b disposed on both ends of the pull rod 812, respectively. The cameras 820a, 820b take photographs and/or videos of objects in a surrounding environment of the piece of luggage 802. In one example, the cameras 820a, 820b take photographs and/or videos of nearby targets and/or users. In some embodiments, the pull rod 812 may further include one or more cameras 820c, 820d (shown in FIG. 8B) on either front side or back side of the pull rod 812, and configured to take photographs and/or videos of nearby targets and/or users. The cameras 820a-820d may face outwards from the piece of luggage 802. In some embodiments, the cameras 820a-820d can be configured to recognize the target.

The self-driving system 800 includes one or more proximity cameras 814a-814d (four are shown in FIGS. 8A and 8B). The one or more proximity cameras 814a-814d are disposed on the pull rod 812 and/or the connecting rod 818 of the handle 810. The one or more proximity cameras 814a-814d are disposed on the lower portion of the pull rod 812. In one example, one of the four proximity cameras 814a-814d is coupled to one of four sides of the pull rod 812. Each of the proximity cameras 814a-814d is configured to take images of a target so that the self-driving system 800 can determine a distance of the target user relative to the piece of luggage 802.

The self-driving system 800 includes one or more laser emitters 816a-816d (four are shown in FIGS. 8A and 8B) disposed on the lower portion of the pull rod 812 and below the proximity cameras 814a-114d. Each of the four laser emitters 816a-816d corresponds to one of the four proximity cameras 814a-814d. Each laser emitter 816a-816d is disposed on the same side of the lower portion of the pull rod 812 as the corresponding one of the proximity cameras 814a-814d. Each laser emitter 816a-816d is disposed on one of the four sides of the lower portion of the pull rod 812. Each of the laser emitters 816a-816d is configured to shoot light (such as lasers) in an outward direction from the lower portion of the pull rod 812 and towards one or more targets (such as a user). The light emitted by the laser emitters 816a-816d reflects off of the one or more targets. Each of the proximity cameras 814a-814d includes an optical filter to identify the light emitted from the laser emitters 816a-816d and reflected off of a target to facilitate determining the proximity of the target relative to the piece of luggage 802. The proximity cameras 814a-814d are configured to take an image of a target that includes light emitted from a respective one of the laser emitters 816a-816d and reflected off of the target. Images taken by a proximity camera 814a-814d having a wide-angle lens include one or more targets and reflected light such that the higher the reflected light appears in the image, the farther the target is from the piece of luggage 802 and the proximity camera 814a-814d that took the images.

The self-driving system 800 includes one or more proximity sensors 870a, 870b coupled to a side of the luggage 802. The proximity sensors 870a, 870b are configured to detect the proximity of one or more objects, such as a user. In one example, the proximity sensors 870a, 870b detect the proximity of objects other than the user, to facilitate the piece of luggage 802 avoiding the objects as the piece of luggage 802 follows the user. The proximity sensors 870a, 870b include one or more of ultrasonic sensors, sonar sensors, infrared sensors, radar sensors, and/or LiDAR sensors. The proximity sensors 870a, 870b may work with the cameras 820a, 820b, 820c, 820d the proximity cameras 814a-814d, and/or the laser emitters 816a-816d to facilitate the piece of luggage 802 avoiding obstacles (such as objects other than the user) as the piece of luggage 802 tracks and follows the user. When an obstacle is identified, the self-driving system 800 will take corrective action to move the piece of luggage 802 and avoid a collision with the obstacle based on the information received from the self-driving system 800 components, such as one or more of the proximity sensors 870a, 870b, the cameras 820a, 820b, 820c, 820d, the proximity cameras 814a-814d, and/or the laser emitters 816a-816d.

Similar to the concept discussed above with respect to FIGS. 3-6B, the self-driving system 800 can be operated under an object recognition mode and directed to follow a target (such as a user) using one or more cameras 820a-820d. The self-driving system 800 can also be operated under a pure proximity-based following mode and directed to follow the target using one or more laser emitters 816a-816d and proximity cameras 814a-814d, which can work together to determine the distance or proximity of the target relative to the luggage 802. In most cases, the self-driving system 800 is operated under a “machine-vision integrated following mode” in which one or more cameras 820a-820d and one or more laser emitters 816a-816d as well as proximity cameras 814a-814d are operated concurrently. That is, the self-driving system 800 is operated under the “object recognition mode” and the “pure proximity-based following mode” simultaneously when following the user. If one or more cameras 820a-820d are partially or fully blocked (e.g., by another object that is moving in between the user and the self-driving system 800), or when the self-driving system 800 follows the user in low ambient light conditions, or when the cameras 820a-820d temporarily lost tracking of the user, the input data transmitted from the one or more cameras 820a-820d, or all cameras 820a-820d may be ignored or not processed by a controller (disposed inside the self-driving system 800) and the self-driving system 800 is switched from the machine-vision integrated following mode to the pure proximity-based following mode which follows the user using only data from the one or more laser emitters 816a-816d as well as proximity cameras 814a-814d. This technique ensures the user is constantly monitored and tracked by the self-driving system 800.

Benefits of the present disclosure include a self-driving system capable of constantly following an object (such as an operator) even when machine-vision cameras are blocked or the self-driving system is operated in low ambient light conditions. The self-driving system can automatically switch between a machine-vision integrated following mode (e.g., machine-vision cameras and proximity sensors are operated concurrently) and a pure proximity-based following mode (e.g., data from machine-vision cameras are not processed and only data from proximity sensors are used to follow the object) in response to changing environmental conditions, such as when the lighting condition is poor or too bright. Identifiable characteristics (a distance between legs of the object, reflective characteristics of skin and clothing, step length/width, or any combination thereof) of the object can be stored in the self-driving system and used to identify the object when the machine-vision cameras lost tracking of the object temporarily.

While the foregoing is directed to embodiments of the disclosure, other and further embodiments of the disclosure thus may be devised without departing from the basic scope thereof, and the scope thereof is determined by the claims that follow.

1. A self-driving system for use in a warehouse, comprising:
a mobile base having one or more motorized wheels, the mobile base having a first end and a second end opposing the first end;
one or more cameras operable to identify an operator;
one or more proximity sensors operable to measure a distance between the operator and the mobile base; and
a controller configured to:
receive data from the one or more cameras and the one or more proximity sensors;
follow the operator using the data from the one or more cameras and the one or more proximity sensors in a machine vision integrated following mode;
switch operation mode of the self-driving system from the machine-vision integrated following mode to a pure proximity-based following mode when the one or more cameras are blocked by a third person moving in between the operator and the self-driving system; and
follow the operator in the pure proximity-based following mode by only using data from the one or more proximity sensors, wherein the follow the operator in the pure proximity-based following mode comprises:
identifying particulars of the operator;
measuring and storing a first speed of the operator moving within a predetermined area detectable by the one or more proximity sensors;
detecting the third person blocking the one or more proximity sensors from detecting the operator, wherein the third person is traveling at a second speed different from the first speed;
moving the self-driving system at the previously measured and stored first speed of the operator;
detecting the operator re-appearing within the predetermined area; and
maintaining a pre-determined distance with the operator to by controlling a speed of the motorized wheels.

2. (canceled)

3. The self-driving system of claim 1, further comprising:
a console coupled in an upright position to the first end of the mobile base, wherein the one or more cameras are coupled to at least one of four sides of the console and/or the mobile base.

4. The self-driving system of claim 3, wherein at least one of the one or more cameras is a Red, Green, Blue plus Depth (RGB-D) camera, and at least one of the one or more proximity sensors is a LiDAR (Light Detection and Ranging) sensor.

5. The self-driving system of claim 1, wherein at least one of the one or more cameras is operable to scan a marker, an QR code, or a barcode of an item.

6. The self-driving system of claim 1, wherein at least one of the one or more cameras is a front facing camera disposed at the console, at least one of the one or more cameras is a down-forward facing camera disposed at the console, at least one of the one or more cameras is a front facing camera disposed at the first end of the mobile base, and at least one of the one or more cameras is a rear facing camera disposed at the second end of the mobile base.

7. The self-driving system of claim 1, wherein the one or more proximity sensors are disposed at a cutout extended around and inwardly from a peripheral edge of the mobile base, and at least one of the one or more proximity sensors is a sonar sensor, an ultrasonic sensor, an infrared sensor, a radar sensor, a sensor that uses light and laser, or any combination thereof.

8. The self-driving system of claim 7, wherein at least one of the one or more proximity sensors is disposed at a corner of the mobile base, and the proximity sensor is operable to sense a field of view of about 270 degrees or greater.

9. (canceled)

10. A self-driving system for use in a warehouse, comprising:
a mobile base having one or more motorized wheels, the mobile base having a first end and a second end opposing the first end;
one or more cameras operable to identify an operator;
one or more proximity sensors operable to generate a digital 3-D representation of the operator; and
a controller configured to:
receive data from the one or more cameras and the one or more proximity sensors;
follow the operator using the data from the one or more cameras and the one or more proximity sensors in a machine vision integrated following mode;
switch operation mode of the self-driving system from the machine-vision integrated following mode to a pure proximity-based following mode when the one or more cameras are blocked by a third person moving in between the operator and the self-driving system;
follow the operator in the pure proximity-based following mode by only using data from the one or more proximity sensors, wherein the follow the target object in the pure proximity-based following mode comprises:
identifying legs of the operator by measuring whether a distance between the legs in the 3-D digital representation falls within a pre-set range;
determining if the operator is moving by calculating a difference in distance between the legs and surroundings at different instant of time;
direct movement of the motorized wheels to follow the operator moving in a given direction;
measuring and storing a first speed of the operator moving within a predetermined area detectable by the one or more proximity sensors;
detecting the third person blocking the one or more proximity sensors from detecting the operator, wherein the third person is traveling at a second speed different from the first speed;
moving the self-driving system at the previously measured and stored first speed of the operator;
detecting the operator re-appearing within the predetermined area; and
maintaining a pre-determined distance with the operator by controlling a speed of the motorized wheels.

11-14. (canceled)

15. The self-driving system of claim 10, further comprising:
a console coupled in an upright position to the first end of the mobile base, wherein the one or more cameras are coupled to one of four sides of the console and/or the mobile base, and at least one of the one or more cameras is operable to scan a marker, an QR code, or a barcode of an item.

16. The self-driving system of claim 10, wherein at least one of the one or more cameras is a Red, Green, Blue plus Depth (RGB-D) camera and at least one of the one or more proximity sensors is a LiDAR (Light Detection and Ranging) sensor.

17. The self-driving system of claim 10, wherein the one or more proximity sensors are disposed at a cutout extended around and inwardly from a peripheral edge of the mobile base.

18. (canceled)

19. A self-driving system for use in a warehouse, comprising:
a mobile base having one or more motorized wheels, the mobile base having a first end and a second end opposing the first end;
one or more cameras operable to identify an operator;
one or more proximity sensors operable to measure a distance between the operator and the mobile base; and
a controller configured to:
identify the operator by the one or more cameras under a machine-vision integrated following mode;
drive the one or more motorized wheels to follow the operator based on the distance between the operator and the mobile base measured by the one or more proximity sensors;
record relative location information of the operator to the mobile base constantly; and
switch operation mode of the self-driving system from the machine-vision integrated following mode to a pure proximity-based following mode when the one or more cameras are blocked by a third person moving in between the operator and the self-driving system, wherein data from the one or more cameras and the one or more proximity sensors are both used for following the operator in the machine-vision integrated following mode, wherein only data of the latest relative location information from the one or more proximity sensors are used for following the operator in the pure proximity-based following mode, and wherein the follow the operator in the pure proximity-based following mode comprises:
identifying legs of the operator;
measuring and storing a first speed of the operator moving within a predetermined area detectable by the one or more proximity sensors;
detecting the third person blocking the one or more proximity sensors from detecting the operator, wherein the third person is traveling at a second speed different from the first speed;
moving the self-driving system at the previously measured and stored first speed of the operator;
detecting the operator re-appearing within the predetermined area; and
maintaining a pre-determined distance with the operator by controlling a speed of the motorized wheels.

20. (canceled)

21. The self-driving system of claim 1, wherein the particulars of the operator are legs of the operator, and wherein the follow the target object in the pure proximity-based following mode further comprises monitoring and storing identifiable characteristics associated with the operator, wherein the identifiable characteristics comprises pre-set range of a distance between the legs, reflective characteristics of skin and clothing, step length, stride length, step width, double support time, step frequency, or combinations thereof.

22. (canceled)

23. The self-driving system of claim 1, wherein the identifying the particulars of the operator comprises measuring a distance between the particulars.

23. (canceled)

24. The self-driving system of claim 23, wherein the maintaining a pre-determined distance with the operator comprises keeping the operator within the predetermined area.

25. The self-driving system of claim 19, wherein at least one of the one or more cameras is a Red, Green, Blue plus Depth (RGB-D) camera, and at least one of the one or more proximity sensors is a LiDAR (Light Detection and Ranging) sensor.

26. The self-driving system of claim 19, wherein at least one of the one or more cameras is operable to scan a marker, an QR code, or a barcode of an item.
